(19) United States
(12) Patent Application Publication
(10) Pub. No.: US 2006/0282822 A1
(43) Pub. Date: Dec. 14, 2006

(54) System and method for processing RSS data using rules and software agents

(76) Inventor: Guoqing Weng, Frederick, MD (US)

Correspondence Address: GUOQING WENG, 9368 Penrose St, Frederick, MD, 21704, US

(21) Appl. No.: 11/390,626

(22) Filed: Mar. 28, 2006

Related U.S. Application Data
(60) Provisional application No. 60/668,556, filed on Apr. 6, 2005.

(51) Int. Cl. G06F 9/44

(52) U.S. Cl. 717/114

(57) ABSTRACT

A system contains a list of vocabulary, actions, rule templates, agent templates and caches that allow users to create, update and delete software agents and rules to process RSS (Really Simple Syndication) data. Rules are defined in the format of “if/then” or “if/then/else”, using vocabulary and actions in the predefined lists and rule templates. Every user can define one to many numbers of rules in the system. RSS Schemas are used to define part of the vocabulary list. Every user can define one to many agents. Every user can associate one to many RSS sources and one to many rules with each agent. In this way, RSS data are processed based on user-defined logic.

### CROSS-REFERENCES TO RELATED APPLICATION

This patent application claims the benefit of U.S. Provisional Patent Application Ser. No. 60/668,556, filed on Apr. 6, 2005, in the name of the inventor hereof and entitled “System and method for processing RSS data using rules and software agents”, in which application is incorporated.

### FIELD OF THE INVENTION

The present invention relates to the field of XML data processing, and more particularly, to a system and method for enabling users to process RSS data using rules and software agents.

1. Description of the Related Arts

Current existing systems process RSS data using mechanism called aggregation. These systems allow users to subscribe a number of RSS and process them together. Some systems also allow users to define personalized policy using mechanism called configuration. Both of these systems do not allow users to define logic using rules. The system in this invention not only allows users to define rules, but also allow any number of rules to be created. Therefore, the system in this invention is more powerful and more flexible. It allows users to define much more complicated logic. Since the rule syntax is close to English and user-friendly graphic user interfaces are provided, users are able to use the system without any training.

2. Background of the Invention

RSS is a Web content syndication format. Its name is an acronym for Really Simple Syndication. RSS is a dialect of XML. All RSS files must conform to the XML 1.0 specification, as published on the World Wide Web Consortium (W3C) website. More information about RSS can be found at http://blogs.law.harvard.edu/tech/rss.

ATOM is a simple way to read and write information on the web, allowing you to easily keep track of more sites in less time, and to seamlessly share your words and ideas by publishing to the web. Atom can be viewed as another flavor of RSS. More information about Atom can be found at http://www.atomenabled.org/

### SUMMARY OF THE INVENTION

The present invention provides a system and method for processing RSS data using rules and software agents. Users are able to create their own software agents and define rules for these software agents, to process the RSS data they want to process.

The system contains a list of vocabulary, actions, rule templates, agent templates and caches that allow users to create update and delete software agents and rules to process RSS (Really Simple Syndication) data. Rules are defined in the format of “if/then” or “if/then/else”, using vocabulary and actions in the predefined lists and rule templates. Every user can define one to many numbers of rules in the system. RSS Schemas are used to define part of the vocabulary list. Every user can define one to many agents. Every user can associate one to many RSS sources and one to many rules with each agent. In this way, RSS data are processed based on user-defined logic.

The list of vocabulary contains all elements and attributes of all versions of RSS schema, including other flavor of RSS such as ATOM schema. The list of vocabulary contains other variables that are not in RSS and ATOM schema. The list of vocabulary is extensible. More variables can be added to the list to handle new versions of RSS and ATOM schemas. More variables can be added to the list to provide more functionality to the system.

The list of actions that contains: displaying data, sending email, creating another file and creating another RSS feed etc. The list of actions that is extensible.

The rule templates have base format of “if/then” and “if/then/else”. The rule templates allow users to select vocabulary from the list as part of the rule conditions. The rule templates allow users to select action(s) from the action list as part of the rule consequences.

The agent template allows users to associate RSS web addresses with the agent. The agent template allows users to associate cached RSS data with the agent. The agent template allows users to associate one to many rules with the agent. The agent template allows users to define execution policy(policies) for the agent. The agents take action(s) if rule condition(s) is(are) satisfied based on RSS source(s). The agents use rule engine to process rules.

The caches allow users to store historic RSS data.

The method comprises: Creating, updating and deleting software agents to process RSS data; Creating, updating and deleting rules to process RSS data; Defining cache policy for historic RSS data; Defining RSS sources for the agents; Associating rules with the agents; Defining agent execution policy; Executing agents based on user-defined policy; Selecting a variable from the vocabulary list to add a condition to a rule, while creating or updating a rule; Selecting an action from the action list to add an action to a rule, while creating or updating a rule.

### BRIEF DESCRIPTION OF THE DRAWINGS

The accompanying drawings illustrate several embodiments of the invention and, together with the description, serve to explain the principles of the invention.

FIG. 1 is a screen shot depicting an example of a browser window, where the left panel of the browser window is displaying two agents: DiggAgent and DiggMemoAgent. DiggAgent is associated with four rules: Digged, Rule1, Rule2, Rule3, and Rule4. DiggMemoAgent is associated with three rules: OnBoth, RuleA, and RuleZ.

FIG. 2 is a screen shot depicting an example of a browser window, where the browser window is displaying a rule template, which serves as a starting point for defining rules.

FIG. 3 is a screen shot depicting an example of a browser window, where the browser window is displaying a sample rule with name “Digged”.

FIG. 4 is a screen shot depicting an example of a browser window, where the browser window is displaying a vocabulary dropdown list for defining rule conditions. For example, condition “Title of channel1 contains Digg” can be defined by selecting “Title of <channel>” from the dropdown list and typing “Digg”.

FIG. 5 is a screen shot depicting an example of a browser window, where the browser window is displaying an action dropdown list for defining rule actions. For example, action “Add this RSS to my feed list” can be defined by selecting it from the dropdown list.

FIG. 6 is a screen shot depicting an example of a browser window, where the right panel of the browser window is displaying agent properties, which could include execution policy such as “Run every 4 hours” etc.

FIG. 7 is a screen shot depicting an example of a browser window, where the left panel of the browser window is displaying agent template: an agent with name “SampleAgent”. SampleAgent has a blank rule with name “Rulel”.

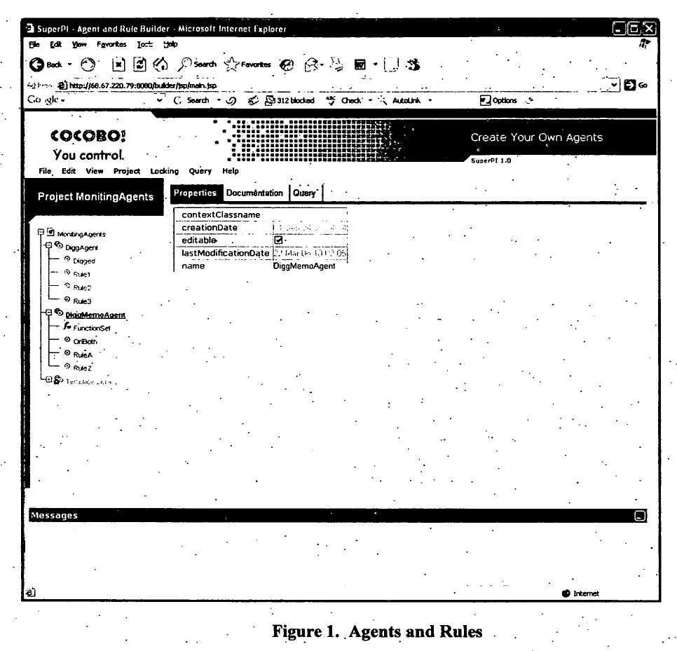

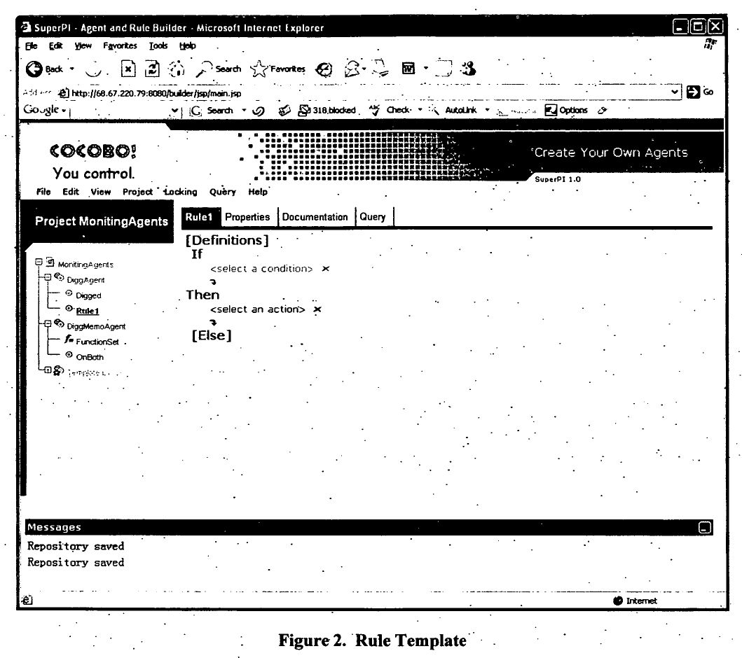

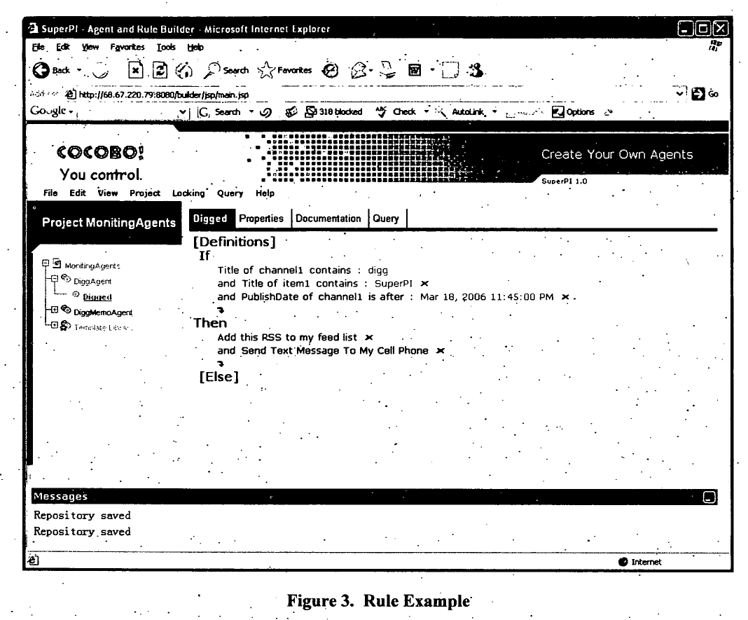

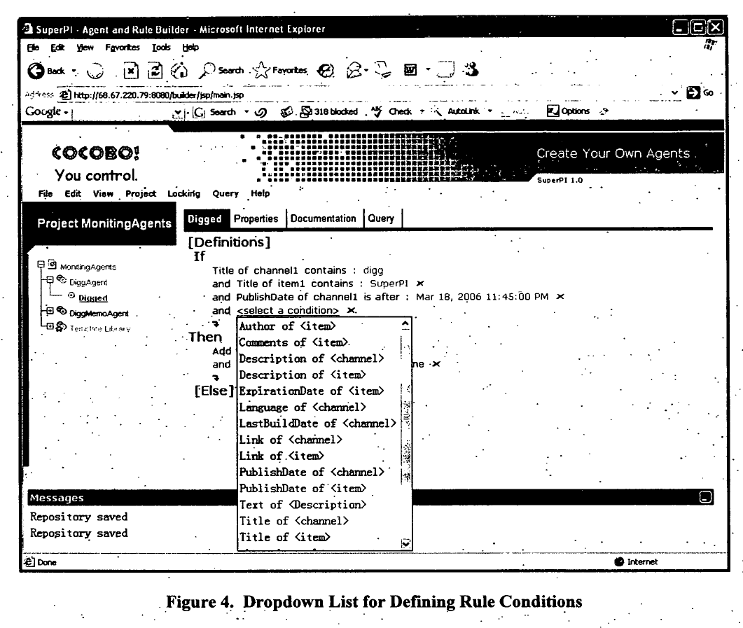

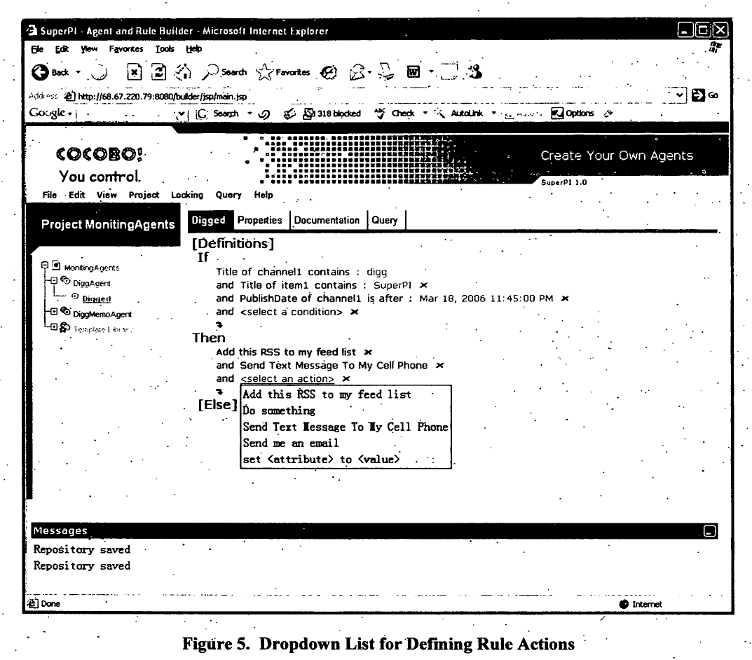

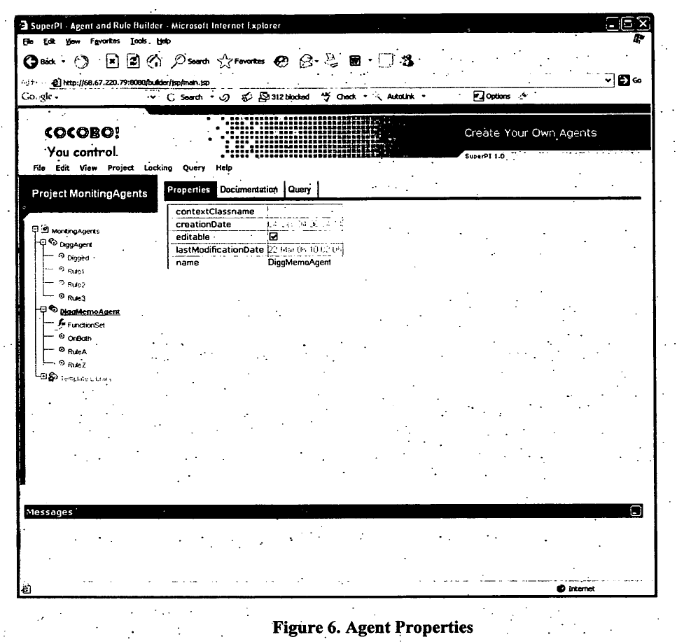

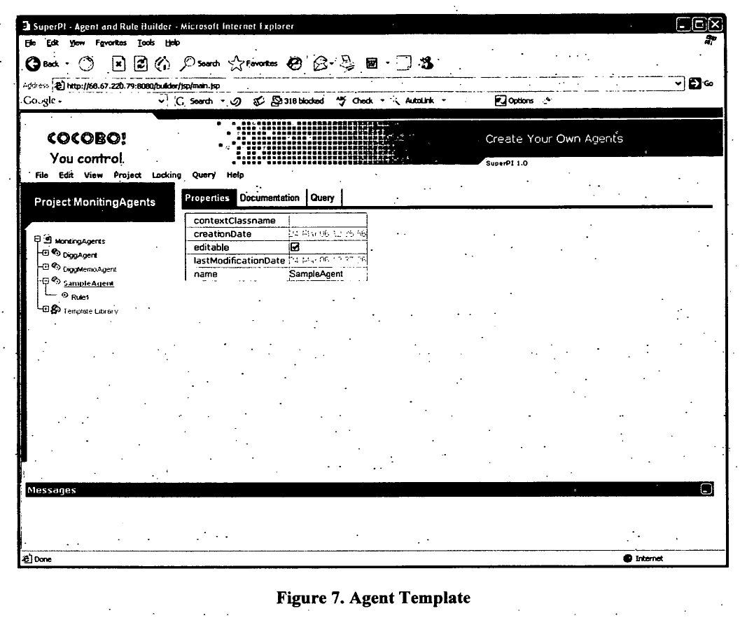

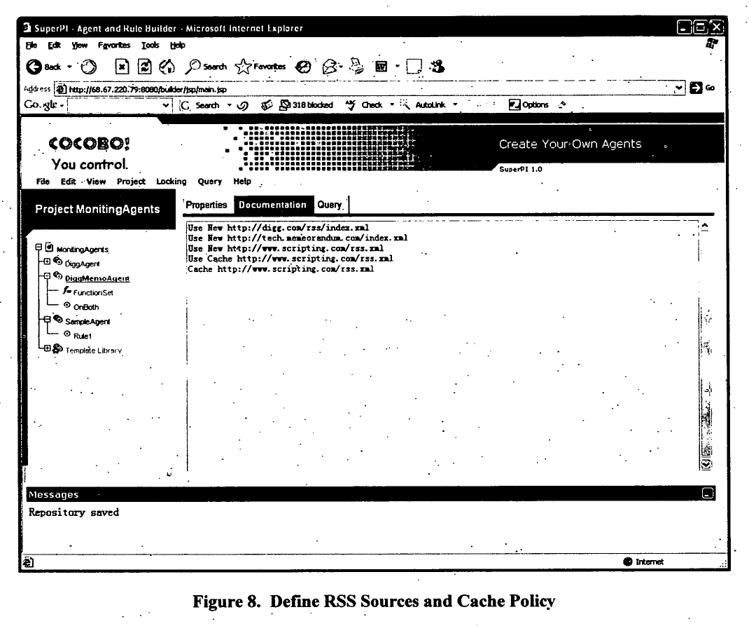

FIG. 8 is a screen shot depicting an example of a browser window, where the right panel of the browser window is displaying RSS source specification and cache policy specification: Agent DiggMemoAgent will process following RSS sources and cache one RSS feed:
Use New http://digg.com/rss/index.xml
Use New http://tech.memeorandum.com/index.xml
Use New http://www.scripting.com/rss.xml
Use Cache http://www.scripting.com/rss.xml
Cache http://www.scripting.com/rss.xml
   “Use New” means the latest RSS feeds from original web site will be one of the sources for the agent to process. “Use Cache” means the RSS feeds from the cache will be one of the sources for the agent to process. “Cache” means the agent will cache the latest RSS feeds from original web site.

One skilled in the art will recognize that these Figures are merely examples of the operations of the invention according to one embodiment and that other user interface arrangements and modes of operation can be used without departing from the essential characteristics of the invention.

### DETAIL DESCRIPTION OF THE EMBODIMENTS

The present invention is now described more fully with reference to the accompanying Figures, in which several embodiments of the invention are shown. The present invention can be embodied in many different forms and should not be construed as limited to the embodiments set forth herein. Rather, these embodiments are provided so that this disclosure will be complete and will fully convey the invention to those skilled in the art.

Once a software agent is defined, it will run on the back end, based on its execution policy. For example, if the policy is “run every four hours”, then the agent will run every four hours automatically. In each execution, the agent will get RSS feeds based on predefined RSS sources first. Then it'll match RSS data with conditions defined in the associated rules. If all conditions are satisfied in a rule, then corresponding actions defined in the rule will be executed. Note this describes the high level process instead of detailed algorithm followed by the agent. Each agent can be activated and deactivated through its execution policy. All agents will use a rule engine to execute rules.

Vocabulary list, which is used to define rule conditions, will be provided to the users. This vocabulary list is derived from RSS schema and ATOM schema It includes “Title of channel”, “PublishDate of channel”, “Description of item”, etc. This vocabulary list is extensible to handle new version(s) of RSS and ATOM schema. A richer meta-model may also add more vocabulary into the list. Example includes: “All feeds”, “At least one feed”, “Counter”, etc.

Action list, which is used to define rule actions, will be provided to the users. Users will choose which action(s) to take if all conditions in a rule are satisfied. This action list is extensible. More and more actions will be added to the system.

It will be understood by those skilled in the relevant art that the above-described implementations are merely exemplary, and many changes can be made without departing from the true spirit and scope of the present invention.

What is claimed is:

1. A computer-implemented system for processing RSS data The system comprises: a list of vocabulary, actions, rule templates, agent templates and caches that allow users to create, update and delete software agents and rules to process RSS (Really Simple Syndication) data.

2. The system of claim 1, the list of vocabulary contains all elements and attributes of all versions of RSS schema, including other flavor of RSS such as ATOM schema.

3. The system of claim 1, the list of vocabulary contains other variables that are not in RSS and ATOM schema.

4. The system of claim 1, the list of vocabulary is extensible. More variables can be added to the list to handle new versions of RSS and ATOM schemas. More variables can be added to the list to provide more functionality to the system.

5. The system of claim 1, the list of actions that contains: displaying data, sending email, creating another file and creating another RSS feed.

6. The system of claim 1, the list of actions that is extensible.

7. The system of claim 1, the rule templates have base format of “if/then” and “if/then/else”.

8. The system of claim 1, the rule templates allows users to select vocabulary from the list as part of the rule conditions.

9. The system of claim 1, the rule templates allows users to select action(s) from the action list as part of the rule consequences.

10. The system of claim 1, the agent template allows users to associate RSS web addresses with the agent.

11. The system of claim 1, the agent template allows users to associate cached RSS data with the agent.

12. The system of claim 1, the agent template allows users to associate one to many rules with the agent.

13. The system of claim 1, the agent template allows users to define execution policy(policies) for the agent.

14. The system of claim 1, the caches allow users to store historic RSS data.

15. The system of claim 1, the agents take action(s) if rule condition(s) is(are) satisfied based on RSS source(s).

16. A computer-implemented method for processing RSS data. The method comprises:
Creating, updating and deleting software agents to process RSS data;
Creating, updating and deleting rules to process RSS data;
Defining cache policy for historic RSS data;
Defining RSS sources for the agents;
Associating rules with the agents;
Defining agent execution policy;
Executing agents based on user-defined policy.

17. The method of claim 16, selecting a variable from the vocabulary list to add a condition to a rule, while creating or updating a rule.

18. The method of claim 16, selecting an action from the action list to add an action to a rule, while creating or updating a rule.
